(19) United States
(12) Patent Application Publication
(10) Pub. No.: US 2016/0192072 A1
(43) Pub. Date: Jun. 30, 2016

(54) DIGITAL MEDIA DISTRIBUTION SYSTEM

(71) Applicants: Martin Dalgleish, Glasgow (GB); Alastair Brown, Glasgow (GB)

(72) Inventors: Martin Dalgleish, Glasgow (GB); Alastair Brown, Glasgow (GB)

(73) Assignee: SIMPLE AUDIO LTD., Glasgow, Strathclyde (GB)

(21) Appl. No.: 14/235,443

(22) PCT Filed: Jul. 27, 2012
(86) PCT No.: PCT/GB2012/051821

§ 371 Date: Mar. 24, 2015

(30) Foreign Application Priority Data
Jul. 27, 2011 (GB) 1112926.9

(51) Int. Cl. H04R 5/04; H04L 12/10

(52) U.S. Cl. CPC H04R 5/04; H04L 12/10; H04W 84/12

(57) ABSTRACT

A digital media distribution system, for use in several different spaces or rooms each of which is provided with electric power from a common supply system, and the system operable using Ethernet-over-powerline. The system comprises a digital media source device, such as a computer, which holds digital media files, and a signal transmission means. The space(s) have a local module connected to the power supply system, the local module being adapted to decode media signals carried on the power supply system. Selected media files are delivered as digital signals from the source device, over the power supply system to the local module. The local module is a device that produces audible and/or visual stimuli to be heard and/or seen by a person in the vicinity, such as one or more loudspeakers and/or display screens.

This invention relates to systems for distributing digital media from one or more source devices to selected ones of multiple spaces within a building or the like.

The invention has particular application to distribution of audio within multiple rooms of a dwelling and will be described herein in that context. However, the invention may also be applied for example in commercial premises, or for handling audio/video data streams, or text and the like.

In the field of domestic audio systems, a single source device (radio tuner, CD player, etc.) may be provided in a given room together with an amplifier and speakers, and repeated in any other room where audio is desired. This can be wasteful of equipment, and there is an obvious desire to use a single source to supply sound in multiple rooms. This can be done by hard wiring a central source and amplifier to speakers in individual rooms, but such an approach requires significant intervention in the physical structure (attaching cabling, making holes in walls and the like) which is often undesirable. Also, with this approach it is not easy to play different music in different rooms at the same time.

There are known systems which wirelessly relay audio from a single source device to selected ones of multiple rooms.

In one such system, the audio source comprises audio files, for example MP3 files, stored on a computer which also acts as a central controller. In each room, a unit comprising an amplifier and a wireless communication module and optionally a power amplifier feeds loudspeakers. The computer and the communications modules create a wireless mesh. Any music from the computer can be played in any suitably equipped room. This system suffers from a number of disadvantages. It uses Wi-Fi based on a form of the 802.11 standard which does not provide a good data rate, and also degrades the performance of other equipment (for example an Internet-connected computer) using Wi-Fi in the same area. It also involves the problems common to Wi-Fi within a building, such as poor signal propagation through solid masonry walls or where the path is interrupted by large metal objects.

The present invention accordingly seeks to provide an improved system for uses including the distribution of audio signals from a single source to multiple rooms within premises.

The present invention, in one aspect, provides a digital media distribution system, for use in a plurality of spaces each of which is provided with electric power from a common supply system, comprising:
a digital media source device holding a plurality of digital media files;
signal transmission means for delivering selected media files from the source device as digital signals over the power supply system;
an output means discernible by a user in each of said spaces;
at least one of said spaces having its output means supplied by a local module connected to the power supply system, the local module being adapted to decode media signals carried on the power supply system.

The expression “output means discernible by a user” is used herein to mean any device which produces audible and/or visual stimuli to be heard and/or seen by a person in the vicinity, typically one or more loudspeakers and/or display screens.

Preferably, each of the local modules has a pre-assigned address, and the signal transmission means is operable to forward a selected media file to one or more selected addresses. This allows different media to be played in different spaces.

Preferably, the signal transmission means and the output means communicate by Ethernet-over-powerline.

In particularly preferred forms of the invention, the digital media source holds a plurality of audio files, and each of the output means comprises one or more loudspeakers.

The audio files are conveniently held as a library, and the source device periodically forms a separate index of the library. In this way, the operation of the system does not interfere with the creation and maintenance of the library.

The system may optionally include a handheld remote control adapted to communicate via the local modules with the source device, in order to enhance user convenience. The remote control may suitably communicate via a radio frequency link, preferably RF4CE; this minimises battery usage and can also operate in co-existence with a Wi-Fi system without mutual interference. The remote control preferably includes a local memory for holding metadata associated with the audio file index.

The central source device may be a general purpose computer communicating with a router which in turn is connected to a powerline adaptor. Alternatively, the central source device may be a local module additionally provided with a digital file memory such as a hard disc drive.

From another aspect, the present invention provides a method of distributing digital media within a plurality of spaces each of which is provided with electric power from a common supply system, from a digital media source device holding a plurality of digital media files, the method comprising:
transmitting selected media files from the source device as digital signals over the power supply system;
decoding media signals carried on the power supply system within one of said spaces; and
supplying the decoded signals to an output means discernible by a user in the selected space.

Preferably each of the local modules has a pre-assigned address, and a selected media file is forwarded to one or more selected addresses.

Preferably also, the digital media files are audio files, and each of the output means comprises one or more loudspeakers.

A further aspect of the invention resides in a local module for use in the above system, comprising an Ethernet-over-powerline receiver, a codec, and a pre-amplifier. The local module may optionally include a power amplifier for connection direct to loudspeaker(s).

In another aspect, the invention provides a remote control for use in the above system, comprising a handheld housing having a display screen and user input means, radio frequency signalling means for communicating with the local module, and a memory for storing metadata relating to the indexed files. The metadata is preferably loaded and updated by physical connection to the source device, preferably while being recharged via USB.

An embodiment of the invention will now be described, by way of example only, with reference to the drawings, in which:

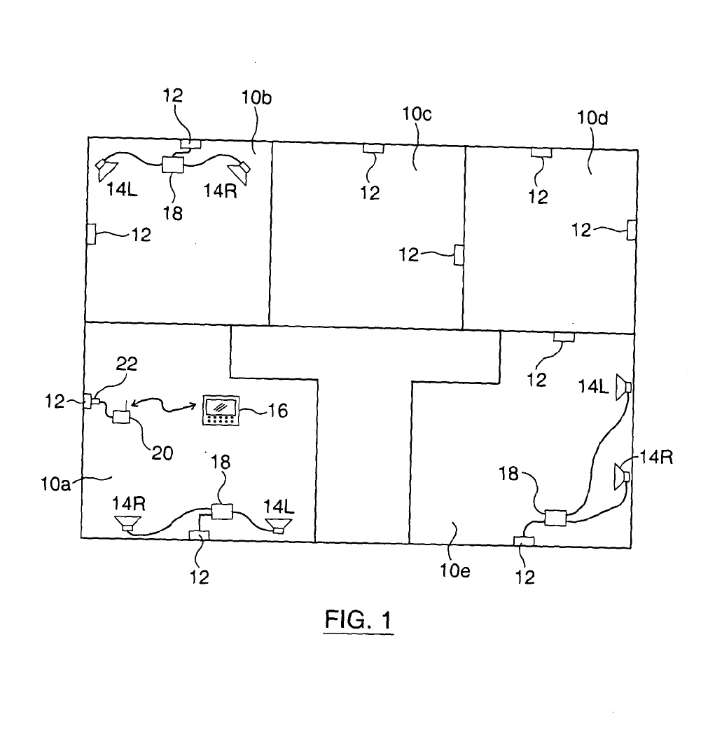

FIG. 1 is a schematic overview of a domestic multi-room audio system forming one embodiment of the present invention;

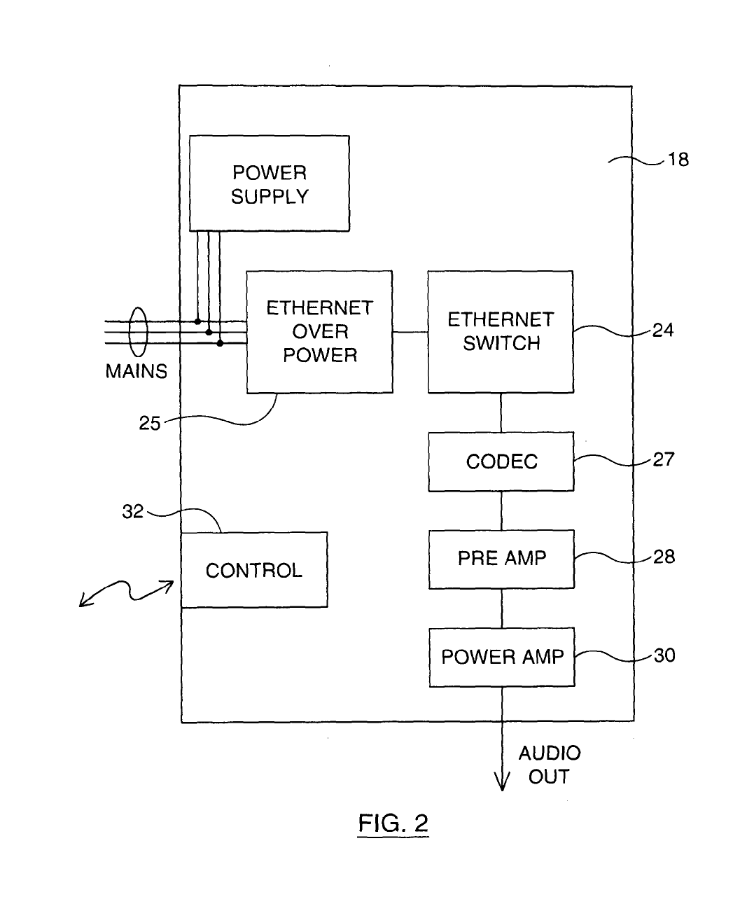

FIG. 2 is a block diagram of a module used in the system;

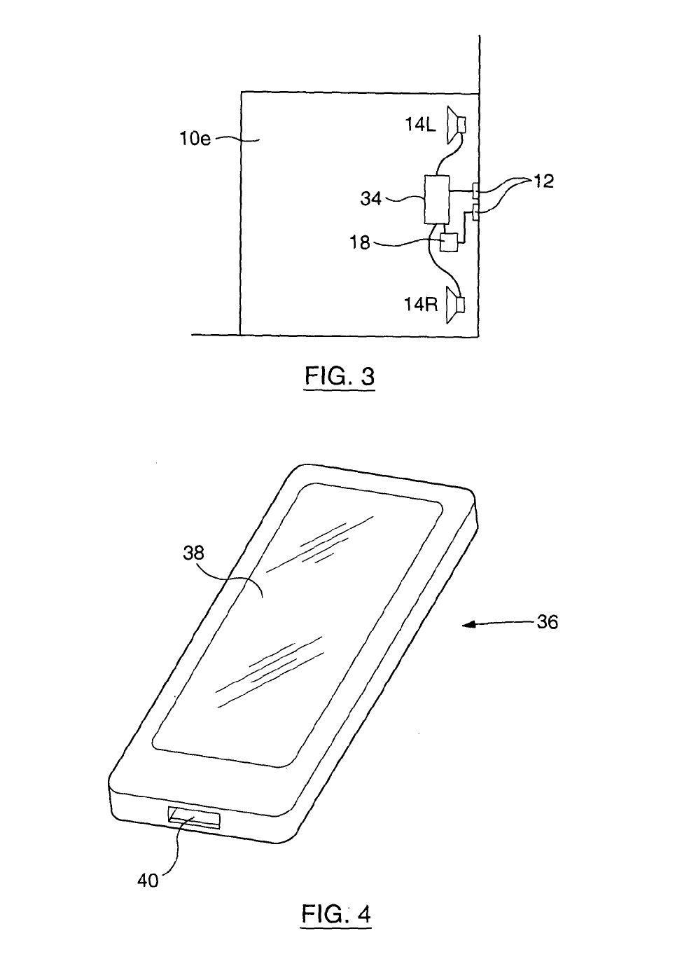

FIG. 3 illustrates a variant of the system of FIG. 1; and

FIG. 4 is a perspective view of a remote control which may optionally be used in the system.

Referring to FIG. 1, a house has a number of rooms 10a, 10b. Each room is provided with one or more power sockets (outlets) 12. Selected rooms are provided with loudspeakers 14R, 14L.

The audio source is a computer 16, in one room 10a, which stores audio tracks as MP3 files and is provided with software for indexing, selecting and forwarding these files. The computer 16 is connected to a standard wireless router 20 which communicates with an adaptor 22 inserted in a power socket 12. The adaptor 22 is a powerline communication adaptor, operating preferably to the standard of the HomePlug Powerline Alliance and providing Ethernet-over-powerline communication. Thus selected audio tracks can be transmitted over the power line system of the house.

The system makes use of room modules 18. Each module 18 is connected to a socket 12 to receive both power and audio signals, and feeds loudspeakers 14.

As seen in FIG. 2, the room module 18 comprises an internal powerline communication adaptor formed by an Ethernet switch 24 and an Ethernet-over-power module 25, a power supply 26, a codec 27 and pre-amplifier 28, and an audio power amplifier 30. Optionally, a control circuit 32 may be provided for cooperation with a remote control to be described below.

Each of the room modules 18 is pre-set with an address, and the software at the computer 16 addresses the desired file to the desired room module(s) 18 by using the normal Ethernet protocol. The user can also control volume, balance etc. from the computer by commands sent in the same way, using a suitable graphical user interface.

It will be appreciated that a room module 18 may be placed anywhere desired in the house, and put into use simply by plugging into the power system and by connecting to loudspeakers. There is thus a minimum of wiring to be carried out, and the installation is neat. The use of powerline communications also gives a high level of security, but optionally the signals passing between the computer 16 and the room modules 18 may be encrypted for additional security.

FIG. 3 shows a modification for use where there is an existing amplified sound system 34, such as a hi-fi system or home cinema system. Here the room module 18 is connected to an input of the sound system 34, suitably by connecting the output of the decoder and pre-amplifier 28 to the power amplifier of the sound system 34. For this purpose a modified form of the room module may be provided, in which the audio amplifier 30 is omitted.

In the system as described thus far, control of what is to be played and where is effected through the computer 16. This will not always be convenient, and the system may optionally include one or more handheld remote controls which may be used at any location in the house. FIG. 4 illustrates a remote control 36 which in this embodiment has a touch-sensitive screen 38 for display and user input. The remote control 36 communicates with the control circuit 32 of each room module 18 by radio frequency communication, preferably using RF4CE standard. This has the advantages of automatically connecting with the nearest module, having a low data rate and short range, and consuming little power, thus giving long battery life. Also, RF4CE can co-exist with a Wi-Fi network without mutual interference.

The remote control 36 communicates with the computer 16 via the nearest room module 18 and the power wiring to effect control of the system from any convenient location.

In preferred forms of the system, the software in the computer 16 is arranged to provide an index of the audio files which is presented as a graphical interface including artwork related to each album or track. In order to give a similar interface on the remote control 36 it is desirable to display the same artwork on the screen 38. However, since downloading and storing such artwork would be time consuming over an RF system, the remote control 36 includes a cache memory for artwork which can be updated by connecting it periodically to the computer 16 via a USB port 40; such connection can also be used to recharge the battery of the remote control 36. This arrangement can be viewed as holding metadata (artwork or other large index files) on the remote control, but working with a single music library at the base computer 16. It is possible to update relatively small amounts of metadata (for example one or two images) by trickling data over RF4CE. Having a standard USB connector also means that any phone type charger can be used and that no proprietary charger is required.

The handling of the music library at the computer 16 may advantageously be organised as follows. The music library itself is stored in any convenient manner, for example using Windows Media Player or similar commercial software. The audio system, however, does not interact directly with the library. Additional software is used to build an index of the library contents, to generate a user interface, and to control communication with the audio system and any remote controls. By using a graphical user interface similar to familiar media players, and by updating the index at very frequent intervals, say every few seconds, the system can operate seamlessly from the user's point of view but with no interference with the music library itself.

The system may be controlled by means other than a dedicated remote control, for example by an i-Phone, i-Pod touch or the like using a downloaded application. The downside of this type of connection is that the iPod needs to be within range of the router. The remote control described above communicates with the closest local module and then adds the controller signal to the network connection. The range of RF4CE is also considerably greater than Wi-Fi so even the remote control is a long way from a player the connection should be robust; the range is tens of meters rather than meters.

The audio source will typically be a general purpose computer, most commonly a laptop or desktop PC with conventional media software. It is also possible, however, for a different source of digital media to be used. In one example, one of the local modules may be modified to include a memory such as a hard disc drive on which the media files are stored. A DVD drive may also be incorporated to allow playback and ripping of audio to the hard disc drive. Control of the system can be effected by means of a control panel incorporated in the modified module, or by means of a remote control as described above.

It will be understood that, since the system forms an Ethernet network, it may include more than one source device and by appropriate addressing any source device can send selected audio files to any desired room. For the same reason, any remote control can be used to control any of the source devices.

As mentioned in the introduction, the preferred embodiment of the present invention has been described with reference to multi-space audio systems, but the invention may have wider application. In particular, the bandwidth of commonly available Ethernet-over-powerline systems is likely to increase and the system of the present invention could thus be readily applied to a multi-space video entertainment system. Equally, the invention could be applied to educational uses, or to the transfer of text, graphics or other data to multiple spaces in a common building.

Other modifications may be made to the foregoing embodiment within the scope of the invention.

1. A digital media distribution system, for use in a plurality of spaces each of which is provided with electric power from a common supply system, comprising:
a digital media source device holding a plurality of digital media files;
signal transmission means for delivering selected media files from the source device as digital signals over the power supply system;
an output means discernible by a user in each of said spaces;
at least one of said spaces having its output means supplied by a local module connected to the power supply system, the local module being adapted to decode media signals carried on the power supply system.

2. The system of claim 1, wherein each of the local modules has a pre-assigned address, and the signal transmission means is operable to forward a selected media file to one or more selected addresses.

3. The system of claim 1, wherein the signal transmission means and the output means communicate by Ethernet-over-powerline.

4. The system of claim 1, wherein the digital media source device holds a plurality of audio files, and each of the output means comprises one or more loudspeakers.

5. The system of claim 4, wherein the audio files are held as a library, and the source device periodically forms a separate index of the library.

6. The system of claim 4, further including a handheld remote control adapted to communicate via the local modules with the source device.

7. The system of claim 6, wherein the handheld remote control communicates via a radio frequency link, preferably RF4CE.

8. The system of claim 6, wherein the handheld remote control includes a local memory for holding metadata associated with the index.

9. The system of claim 1, wherein the source device is a general purpose computer communicating with a router which in turn is connected to a powerline adaptor.

10. The system claim 1, wherein the source device is a local module additionally provided with a digital file memory such as a hard disc drive.

11. (canceled)

12. (canceled)

13. (canceled)

14. (canceled)

15. (canceled)

16. (canceled)

17. (canceled)
